(19) United States
(12) Patent Application Publication
(10) Pub. No.: US 2025/0031148 A1
(43) Pub. Date: Jan. 23, 2025

(54) WAKE-UP TIME RECOMMENDATION BY AN ACCESS POINT

(71) Applicant: Samsung Electronics Co., Ltd., Suwon-si (KR)

(72) Inventors: Vishnu Vardhan Ratnam, Plano, TX (US); Boon Loong Ng, Plano, TX (US); Rubayet Shafin, Allen, TX (US); Peshal Nayak, Plano, TX (US); Yue Qi, Plano, TX (US); Elliot Yuchih Jen, Taipei City (TW)

(21) Appl. No.: 18/766,545

(22) Filed: Jul. 8, 2024

Related U.S. Application Data
(60) Provisional application No. 63/527,458, filed on Jul. 18, 2023.

(51) Int. Cl. H04W 52/02; H04W 88/02; H04W 88/08

(52) U.S. Cl. CPC H04W 52/0229; H04W 52/0219; H04W 88/02; H04W 88/08

(57) ABSTRACT

The following methods and apparatuses are provided which enable an AP MLD to indicate to one or more non-AP MLDs a recommended wake-up time for them on one or more links. The recommended wake time, in some embodiments, may continue for at least one STA over a prescribed number of intervals. Features are also provided for a STA to request a wake-up time recommendation to an AP, along with rules for the STA to obey. In one aspect of the disclosure, an AP sends a wake time recommendation element (WTRE) in a beacon interval. Rather than an immediate wake time, the WTRE includes a prescription recommending that one, more or all stations defer their wakeup times to a recommended wake time.

### CROSS-REFERENCE TO RELATED APPLICATIONS

This application claims the benefit of priority from U.S. Provisional Application No. 63/527,458, entitled “METHOD AND APPARATUS FOR WAKE-UP TIME RECOMMENDATION BY AN ACCESS POINT,” filed Jul. 18, 2023, which is incorporated herein by reference in its entirety.

### TECHNICAL FIELD

This disclosure relates generally to wireless communication, and more particularly to, for example, but not limited to, wake-up time in wireless local area network (WLAN) technology.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been enacted for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput. Current solutions, however, for traffic indication, data retrieval, and premature wake-up can result in remarkably high power consumption and as a result, decreased overall performance.

The description set forth in the background section should not be assumed to be prior art merely because it is set forth in the background section. The background section may describe aspects or embodiments of the present disclosure.

### SUMMARY

In one aspect of the disclosure, an access point (AP) is provided. The AP includes a memory and processor coupled to the memory. The processor is configured to transmit, to one or more stations, a wake time recommendation element (WTRE). The WTRE includes at least (i) an identity of one or more stations; and (ii) a recommended wake time after transmission of the WTRE for the one or more stations to transmit or receive data beginning at the wake time. The processor is further configured to receive, at the recommended wake time from the one or more stations, an indication that the one or more stations are ready to exchange data with the AP.

In various aspects, the recommended wake time is determined based on at least one of a time synchronization function corresponding to an intended wake time, one or more transmit units corresponding to a time gap between transmission of the WTRE and the intended wake time, or an identifier of a beacon segment corresponding to the intended wake time, wherein a beacon interval following transmission of the WTRE is partitioned into equal-length beacon segments.

In various embodiments, the WTRE includes an indication of whether the recommended wake time is for transmission of: downlink traffic from the AP to the one or more stations; uplink traffic from the one or more stations to the AP; or bidirectional traffic for the one or more stations.

In various embodiments, the WTRE includes an indication of whether the recommended wake time is for AP-initiated or triggered transmissions.

In various embodiments, the WTRE includes an indication whether the at least one recommended wake time is optional or mandatory, and a purpose of the recommended wake time.

In various embodiments, the AP is an AP multi-link device (MLD) including one or more affiliated APs, The AP MLD establishes one or more links, each link associated with a respective one of the one or more affiliated APs. During multi-link operation (MLO), the WTRE is configured to indicate one or more links for which the WTRE is valid.

In various embodiments, the WTRE includes a number of stations assigned to a same recommended wake time or a sequence number among the stations assigned the same recommended wake time.

In various embodiments, the WTRE includes an indication whether the recommendation is a long-term recommendation to continue for at least one station over a prescribed time period.

In another aspect of the disclosure, a station in a wireless network is provided. The station includes a memory and a processor coupled to the memory. The processor is configured to transmit a request to send a wake time recommendation element (WTRE) to an access point (AP). The processor is further configured to receive, from the AP, the WTRE including at least (i) an identity of one or more stations; and (ii) a recommended wake time after transmission of the WTRE for the one or more stations to transmit or receive data beginning at the recommended wake time. The processor is also configured to wake up at the recommended time and to transmit, at the recommended time, an indication that the station is ready to exchange data with the AP.

In various embodiments, The station of claim 9, wherein the processor is further configured to follow, in an event of an impending or existing collision between respective transmissions, back-off procedures identified by the AP; and to re-initiate transmission at a designated time to retrieve traffic from the AP after completing the back-off procedures.

In various embodiment, the processor is further configured to receive a trigger frame from the AP requesting the station to transmit a power-save (PS) poll frame at the recommended wake time, and to transmit the PS poll frame to the AP at the recommended wake time.

In various embodiments, one or more of the stations comprise non-AP stations.

In various embodiments, the WTRE includes an indication of a duration that the recommended wake time will remain valid. The station is configured to awaken to perform frame exchanges with the AP at the recommended wake time.

In various embodiments, the station is a non-AP multi-link device (MLD) including one or more affiliated non-AP stations, and the non-AP MLD establishes one or more links, each link associated with a respective one of the one or more affiliated non-AP stations. During multi-link operation (MLO), one or more affiliated non-AP stations transition to an awake state at the recommended wake time on recommended links, the recommended links being indicated by link identifiers included in the WTRE.

In various embodiments, the WTRE includes an indication whether the recommendation is a long-term recommendation to continue for at least one station over a prescribed time period.

In still another aspect of the disclosure, a method performed by an Access Point (AP) includes transmitting, to one or more stations, a wake time recommendation element (WTRE). The WTRE includes at least (i) an identity of one or more stations; and (ii) a recommended wake time after transmission of the WTRE for the one or more stations to transmit or receive data beginning at the wake time. The method further includes receiving, at the recommended wake time from the one or more stations, an indication that the one or more stations are ready to exchange data with the AP.

In various embodiments, the WTRE includes an indication of a duration that the recommended wake time will remain valid. The WTRE includes an indication whether compliance with the at least one recommended wake time is optional or mandatory, and a purpose of the recommended wake time.

In various embodiments, the processor is further configured to determine the recommended wake time based on at least one of a time synchronization function corresponding to an intended wake time, one or more transmit units corresponding to a time gap between transmission of the WTRF and the intended wake time, or an identifier of a beacon segment corresponding to the intended wake time, wherein a beacon interval following transmission of the WTRE is partitioned into equal-length beacon segments.

In various embodiments, the WTRE includes an indication whether the recommendation is a long-term recommendation to continue for at least one station over a prescribed time period.

### BRIEF DESCRIPTION OF THE DRAWINGS

FIG. 1 shows an example of a wireless network in accordance with an embodiment.

FIG. 2A shows an example of an AP in accordance with an embodiment.

FIG. 2B shows an example of a STA in accordance with an embodiment.

FIG. 3 shows an example of multi-link communication operation in accordance with an embodiment.

FIG. 4 shows an example timing diagram of a present AP/Beacon acquisition of service.

FIG. 5A shows an example of a timing diagram with an AP beacon signal including a Wake Time Recommendation Element (WTRE) in accordance with an embodiment.

FIG. 5B shows an example of a timing diagram with multiple beacons and a signaling field including information about the WTRE, in accordance with an embodiment.

FIG. 6 shows an example Beacon Interval (BI) segment allocation list field for the WTRE of FIG. 5A, in accordance with an embodiment.

FIG. 7 shows an example of using a Multi-User-Request To Send (MU-RTS) trigger frame as a criterion for wake-up recommendation in accordance with an embodiment.

FIG. 8A shows an example of a WTRE providing a BI segment indication for multiple links by indicating a Link Set Size, in accordance with an embodiment.

FIG. 8B shows an example of a WTRE providing a BI segment indication for multiple links by setting a Link ID bitmap, in accordance with an embodiment.

FIG. 9 shows an example of a Traffic indication virtual bitmap and its mappings to a BI Segment Allocation List in the WTRE, in accordance with an embodiment.

FIG. 10A shows a WTRE having an Association Identifier (AID) Bitmap element for use in identifying all the AIDs for which the Wakeup time indication applies.

FIG. 10B shows a WTRE using a Wake Time field that indicates the time where the AP indicates the STA(s) to wake up, in accordance with an embodiment.

FIG. 11 shows a timing diagram in which the AP may segment the beacon into different segments and can trigger frames optionally by indicating a random access resource unit (RA-RU) in the WTRE, in accordance with an embodiment.

FIG. 12 illustrates the use by an AP of the WTRE to indicate to STAs a “long term” recommendation of the time when the AP intends to serve the STA with buffered units (BS) it may have, in accordance with an embodiment.

FIG. 13 shows an embodiment in which an AP can transmit a WTRE in an individually addressed WTRE from to a STA to indicate it has BUs for the STA, in accordance with an embodiment, including where multiple times for multiple links are used.

FIG. 14 shows an example timing diagram where a STA can negotiate with an AT for providing an additional wake-up delay for adding to the recommended wake-up time, in accordance with an embodiment.

FIG. 15 shows an example flow diagram of a process for recommending, by an AP, a wake time in accordance with an embodiment.

FIG. 16 shows another example flow diagram of a process for receiving, by a STA from an AP, a WTRE, and for waking at the specified time to retrieve BUs, in accordance with an embodiment.

FIG. 17 is a timing diagram illustrating an alternative embodiment for the AP to use WTRE to apply within specific service periods (SPs) rather than the whole beacon interval, in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Unless otherwise explicitly specified, the following terms apply to the present disclosure. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, or C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

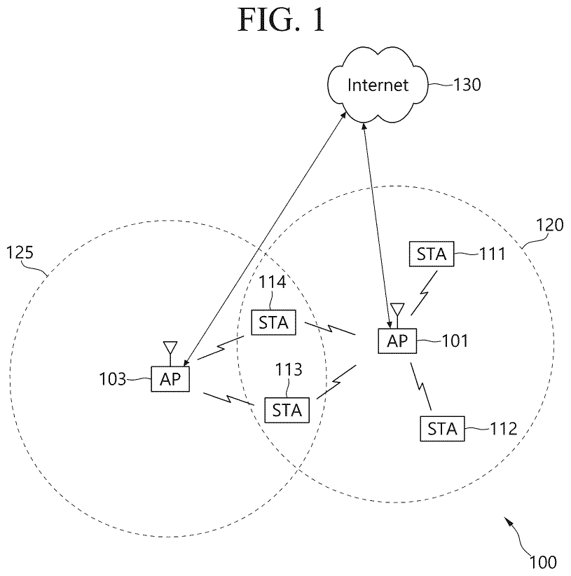

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 includes a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The 8253 may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link devices (MLDs). As noted, conventional standards support multiple bands of operation, such that an AP and a non-AP STA can communicate with each other over links. Thus, both the AP and non-AP STA may be capable of communicating on different frequency bands/links, which is referred to herein as multi-link operation (MLO). Devices capable of MLO are referred to as multi-link devices (MLDs). STAs 111-114 are wireless communication devices, each of which may include one or more non-AP STAs. In such embodiments, STAs 111-114 may be non-AP MLDs.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

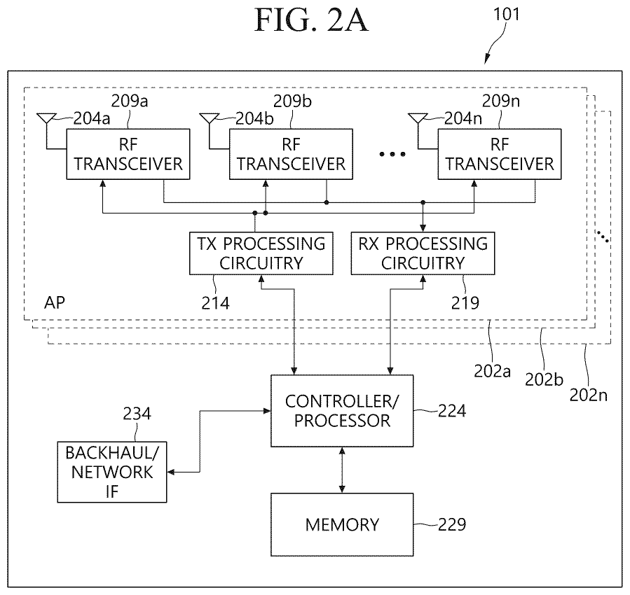

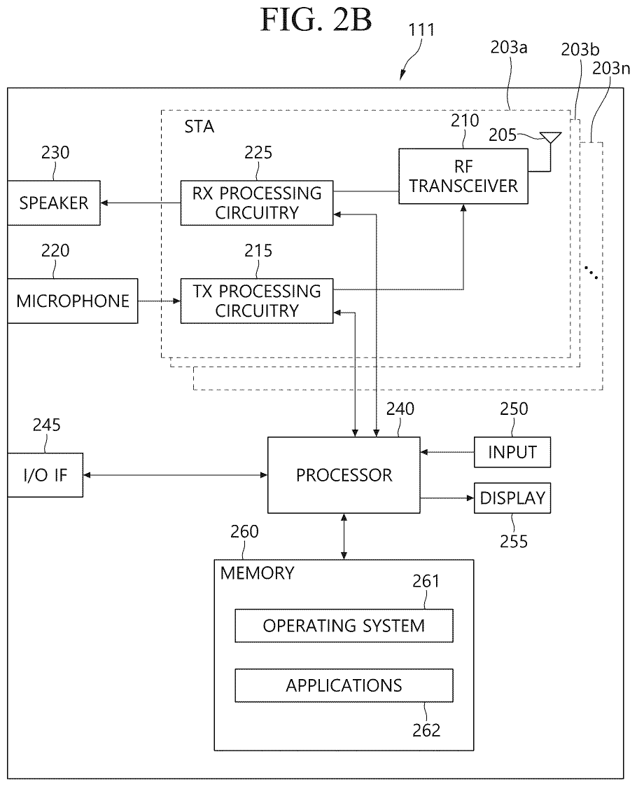

FIG. 2A shows an example of an AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any implementation of an AP.

As shown in FIG. 2A, the AP 101 includes multiple antennas 204a-204n, multiple radio frequency (RF) transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 may support additional functions as well, such as more advanced wireless communication functions. For instance, the controller/processor 224 may support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of a STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, an RF transceiver 210, TX processing circuitry 215, a microphone 220, and RX processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the touchscreen 250 and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

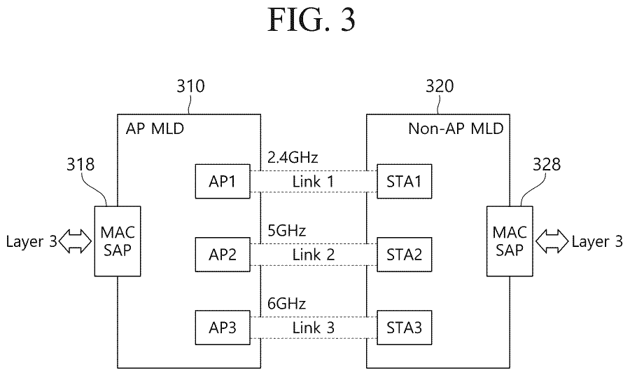

FIG. 3 shows an example of MLD communication operation 300 in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP includes a PHY interface to wireless medium (Link 1, Link 2, or Link 3). The AP MLD 310 includes a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and the Layer 3 recognizes the AP MLD 310 by assigning the single IP address.

The non-AP MLD 320 may include a plurality of affiliated STAs, for example, including STA 1, STA 2, and STA 3. Each affiliated STA includes a PHY interface to the wireless medium (Link 1, Link 2, or Link 3). The non-AP MLD 320 includes a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and the Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency.

To prioritize transmission of different types of traffic, which are identified by a traffic identifier (TID), across the setup links, the non-AP MLD 320 may negotiate a TID-to-link mapping with the AP MLD 310. The TID-to-link mapping allows the AP MLD 310 and the non-AP MLD 320 to determine how frames belonging to TIDs are assigned for transmission on each setup link in the uplink and downlink directions, respectively. When at least one TID associated with a non-AP MLD 320 is mapped to a setup link in either uplink or downlink direction, the link is referred to as an enabled link for the non-AP MLD 320. By default, all TIDs are mapped to all the setup links between the AP MLD 310 and the non-AP MLD 320, and this mapping is referred to as a default TID-to-link mapping. During association, the non-AP MLD 320 can use a negotiation procedure to negotiate a non-default mapping of TIDs to the setup links, by including a TID-to-Link Mapping element in an association request frame or a reassociation request frame. The non-default mapping can be either where all TIDs are mapped to the same subset of setup links, or where not all TIDs are mapped to the same subset of setup links. The AP MLD 310 can also use a broadcast procedure to indicate switching to a non-default mapping for all associated non-AP MLDs. In default mapping mode, all TIDs are mapped to all setup links for downlink and uplink and all setup links are enabled. The non-AP MLD 320 operates under default mapping mode when a TID-to-link mapping negotiation did not occur or was unsuccessful.

The following documents and standards descriptions are hereby incorporated by reference into the present disclosure as if fully set forth herein: (1) IEEE 802.11-2020, “Wireless LAN Medium Access Control (MAC) and Physical Layer (PHY) Specification;” (2) IEEE802.11ax; and (3) IEEE P802.11be/D3.0.

For purposes of this disclosure, a WiFi station (STA) may be in one of two states: (1) an awake state, in which the STA continuously monitors the channel and can transmit or receive packets; and (2) a doze state, in which the STA does not monitor the channel. Examples of (2) include instances where the STA is saving power. Furthermore, a non-AP STA can be in one of two power management states: (1) active mode, in which the STA receives and transmits frames at any time. In this mode, the STA remains in the awake state referenced above. The second state for the non-AP STA is a (2) Power save (PS) mode, in which the STA enters the awake state to receive or transmit frames. Except in the cases of entering the awake state to exchange frames, the STA in PS mode remains in the doze state.

Current versions of the technology include various mechanisms to save power. For example, when a STA is in the PS mode and the state of the STA is in the doze state, the corresponding AP buffers “buffer-able” packets that are addressed to the STA and that cannot be delivered to another STA associated with the same device in active state. These buffered packets, also referred to herein as “buffered units” (BUs), are delivered by the AP when the dozing STA returns to the awake state. The AP periodically uses broadcast or multicast signaling that includes a traffic information map (TIM) to indicate to all the associated non-AP devices about the pending BUs. The AP may also optionally include a multi-link traffic indication element within the beacon frames it transmits. Each AP in the WiFi network may also transmit these elements as a separate periodic broadcast frame. The AP may assign a unique association identifier (AID) to each STA to identify the station with which the AP is dealing. A STA that is associated with an AP and that changes its mode of power management informs the AP of this fact using the power management subfield within the frame control field of transmitted frames. In current solutions, only frames that include an ACK can be used. The subfield “PM” can be set to ‘1’ to indicate power save mode. In addition, power save mechanisms that can be used by a non-AP MLD are currently defined in the above-referenced specifications (1)-(3). These include normal power save mode, unscheduled automatic power save delivery (U-APSD), wireless network management (WNM) power save mode, power save multi-poll mode, spatial multiplexing power save mode, very high throughput (VHT) TXOP power save (where “TXOP” indicates the amount of time an STA can transmit without having to contend for the medium), Target Wake Time (TWT), and the like. In addition, the specifications provide certain features to enable a non-AP device to determine when to be in the “doze” state versus the “awake” state.

For example, to indicate to a STA to determine when it should transition to awake state, the specification for IEEE 802.11ax at reference (2), cited above, also provides several methods to the AP. In one such method, an AP may indicate start times for one or more broadcast TWT service periods (SPs) with a random access resource unit (RA-RU) in the broadcast TWT element that is included in a Management frame. A “TWT SP with RA-RU” is defined as the TWT SP corresponding to a Broadcast TWT Parameter Set field in a TWT element that has a Broadcast TWT ID subfield equal to 0 (meaning that all STAs are members), a Flow Type subfield equal to 0, a Trigger subfield equal to 1, and a Broadcast TWT Recommendation subfield equal to 2. An associated STA that supports the TWT and uplink orthogonal random access (UORA) procedure when operating in PS mode, upon receiving a Beacon frame from its associated AP carrying a TWT element indicating a schedule for TWT SP(s) with RA-RU, may enter the doze state if no other condition requires it to be awake. The STA may transition to awake state at the start of a TWT SP with RA-RU to send a trigger-based PLCP protocol data unit (PPDU) to its associated AP.

In another method, an AP can use aperiodic Opportunistic Power Save (OPS). In this technique, an OPS-capable AP transmits an OPS frame or Fast Initial Link Setup (FILS) frame with broadcast receive address (RA) to provide scheduling info for all OPS-capable STAs. This procedure is accomplished by including an OPS element identifying the OPS period that immediately follows the OPS frame or FILS frame, and a TIM element identifying the AIDs of STAs which will be served in the period. If the OPS-capable AP sets the bit corresponding to an OPS non-AP STA in the traffic indication virtual bitmap field of the TIM element of the OPS frame or FILS Discovery frame to 0, the AP should send neither individually addressed frames to the STA nor Trigger frames with a User Info field that addresses the STA during the OPS period that immediately follows the OPS frame. Such a STA can go to doze (if in power save mode) or be unavailable (if in active mode).

In another method described in the IEEE 802.11ax specification, an AP can use periodic OPS in which an OPS-capable AP splits the beacon interval into several bTWT SPs and provides in beginning of each SP the scheduling information for all OPS-capable STAs. The bTWT recommendation field is set to 3 and bTWT ID is set to 0 (i.e., everyone is a member STA). At the beginning of the SP, the AP transmits a TIM frame or a FILS discovery frame with a broadcast RA and including a TIM element and an OPS element. If the OPS-capable AP sets the bit corresponding to an OPS non-AP STA in the traffic indication virtual bitmap field of the TIM element of the OPS frame or FILS Discovery frame to 0, the AP should send neither individually addressed frames to the STA nor Trigger frames with a User Info field that addresses the STA during the OPS period. Such a STA can go to doze (if in power save mode) or become unavailable (if in active mode).

An “Example of Multi-Link Traffic element construction” is shown in Illustration 35-11 in the IEEE 802.11ax specification, cited above. For non-APs in power save mode, the AP may indicate the presence of traffic using the traffic information map (TIM) element in the beacon frames. Ordinarily, only the TIM element is included. However, the ML traffic indication (MLTI) may be added if at least one non-AP MLD has non-default TID-to-link mapping and includes pending data traffic. One bit in the partial virtual bitmap of the TIM element indicates a traffic presence for an AID (e.g., a STA or an MLD). The TID-to-link mapping mechanism allows determination of how TIDs (Traffic identifiers) are mapped to the links in downlink (DL) and in uplink (UL), also known as TID-to-link mechanism. This mechanism is helpful for the use of preferred link(s) for TID(s) corresponding to high-priority and latency-sensitive traffic. By listening to the TIM element or the MLTI element in the beacon frames, a non-AP STA can be made aware of the presence or absence of buffered data intended for it. For example, if there is traffic, the non-AP STA can send a PS poll or a QoS frame to the AP to fetch the buffered traffic. After receiving the data, the AP may indicate end of traffic by using the more data bit. Thereafter, the STA can revert to the doze state to save power. If, however, there is no traffic indicated in the TIM element from the beginning, the STA can enter doze state directly.

The present mechanism for traffic indication only indicates a presence of buffered traffic at the AP of every beacon. Upon receiving a TIM bit set to one, the non-AP STA transitions to the awake state and sends a PS poll to retrieve the traffic. It is not known how long it will take for the subject non-AP STA to win channel access to send the PS poll or when the AP intends to transmit the buffered traffic to the STA. These uncertainties waste power since the STA may be in a prolonged awake mode as it waits for these eventualities to occur. The power consumption may be particularly significant when operating in the higher frequency bands such as in mm-Wave channels. As an example, using multi-link operation (MLO), the AP may intend to serve an edge STA at a particular time within the beacon interval. If this information is not provided to the non-AP STA, the non-AP STA will waste power by waking up earlier than necessary. To remedy this and other shortcomings with conventional wireless system, a mechanism is needed for the AP or AP MLD to recommend the time when it intends to serve an associated non-AP STA or non-AP MLD on one or more links.

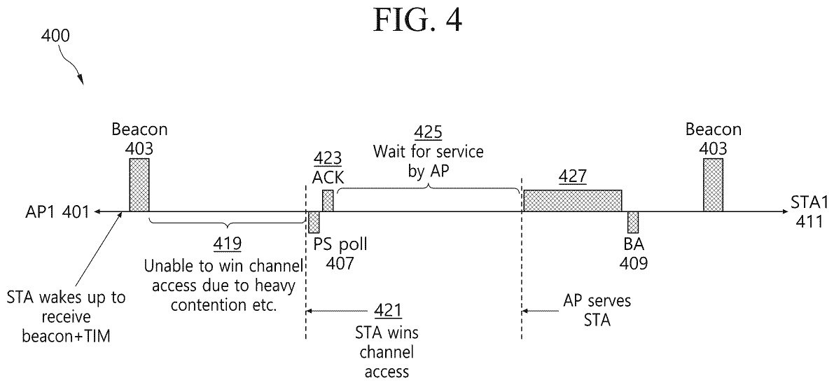

FIG. 4 shows an example timing diagram of a present AP/Beacon acquisition of service. For example, FIG. 4 shows an example of current mechanisms for traffic indication for an STA, which have shortcomings. In FIG. 4, a periodic beacon signal 403 is broadcast from an AP 401 and received by an example non-AP STA1 411. It is assumed that in this diagram at time period 419, the STA1 (now awake) is unable to win channel access due to high contention and channel congestion, which results in the consumption of power that increases with the duration and amount of the channel contention. Thereupon, at time period 421, it is assumed that the STA1 411 is able to win channel access. STA1 transmits a PS poll 407. A PS poll is a control frame sent by the STA to an AP after receiving a beacon continuing the STAs AID in the TIM. After sending an ACK to the STA and making the STA remain awake for an additional period of time 425 to receive the service, the AP finally serves the message 427 destined for the non-AP STA. The destination STA1 411 thereafter serves a block acknowledgment 409 after successfully receiving the message 427. A beacon 403 is then transmitted in periodic fashion.

As illustrated in FIG. 4, near the beginning of the example activity, the STA1 411 may wake up to receive the next beacon and the TIM. Among other problems, the traffic indication map only indicates the presence of buffered traffic at the AP in every beacon. Upon receiving a TIM bit set to one, the non AP-STA transitions to the awake state and sends a PS poll to retrieve the data. In so doing, the non-AP STA may encounter at least two types of delays. First, it is unknown how long it will take for the non-AP STA to win channel access (419) to send a PS poll 407 to the AP, or when the AP intends to transmit, or is capable of transmitting, the buffered traffic (427) to the STA. This lack of knowledge concerning these types of unnecessary delays results in potentially significant wasting of power. The power consumption wastage can be particularly pronounced in the mm-Wave links, the latter of which already involves the transfer of high frequency bands using high energy, which problem worsens with more non-AP STAs in this mode. Further, in some cases, the non-AP STA may be incapable of sending the PS poll, whether due to hardware or low-quality link margin limitations that may be involved. In specific cases such as multi-AP coordination, the AP may intend to serve an edge STA at a specific time within the TBTT, for example. If this information is not provided to the non-AP STA, the latter entity will still waste power by virtue of waking up early as noted above. The principal reason for encountering this issue is that no mechanism exists for the AP (or the AP MLD) to recommend the time when the AP intends to serve a corresponding non-AP STA or non-AP MLD on one or more links.

Accordingly, the present disclosure introduces various features that overcome these limitations. Among other benefits, the availability of this advanced knowledge assists the non-AP STAs in determining when they should transition to an awake state, which in turn heightens the quality of overall network management, reduces latencies, enables effective multi-AP coordination and more efficient savings in STA power.

Initially, while the written description often focus on the terms AP and non-AP STA in connection with various embodiments, these embodiments are equally applicable to recommendations sent by an AP MLD to a corresponding non-AP MLD, including where a recommendation may extend to one or more links.

To this end, various features described further below include embodiments related to at least the following: (1) providing methods and apparatuses for an AP MLD to indicate to one or more AP MLDs a recommended wake-up time for the non-AP MLDs on one or more links; (2) providing methods and apparatuses for an AP MLD to provide a long-term recommendation of a periodic wakeup time to one or more corresponding non-AP MLDs; (3) providing methods and apparatuses for an AP MLD to provide a long-term recommendation of a wakeup time to one or more corresponding non-AP MLDs within periodic service periods (SPs); (4) providing methods and apparatuses for a STA to request a wakeup time recommendation from an AP and the rules for the non-AP STA to obey upon waking up at the recommended time; and (5) providing unique variations of these features and solutions for both the AP and the STA to maximize power conservation and network QoS when employing these techniques.

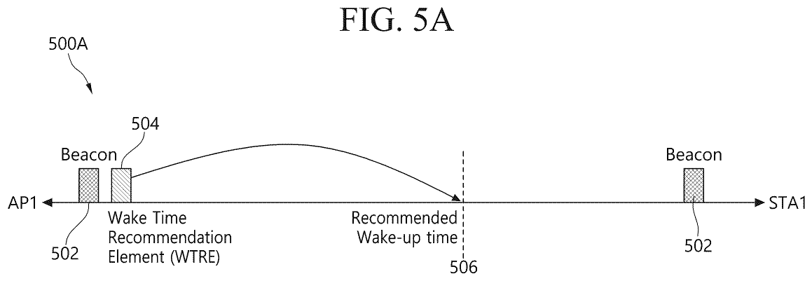

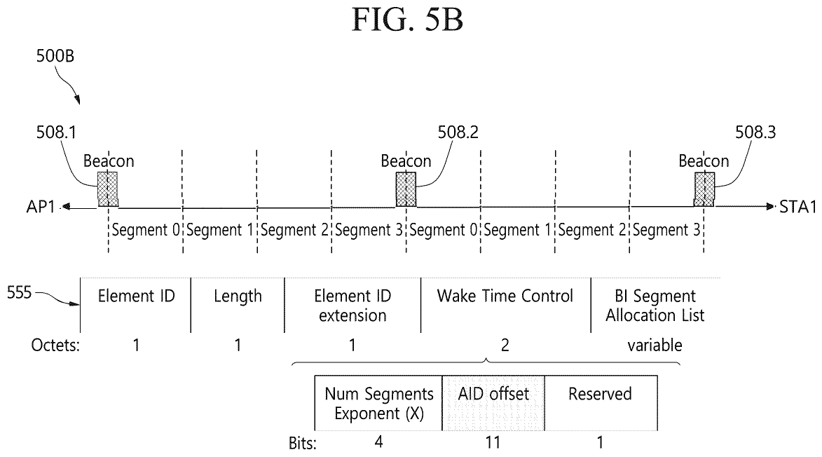

Accordingly, in one aspect of the present disclosure, the AP transmits a Wake Time Recommendation Element (WTRE) to indicate to one or more corresponding STAs the time that the AP recommends each STA to awaken for retrieving the data. FIG. 5A shows an example of a timing diagram 500A with an AP beacon signal 502 including a Wake Time Recommendation Element (WTRE) 504 in accordance with an embodiment. An AP is associated with STA1 in this illustration.

It should be noted that the WTRE 504 may in some embodiments be appended to, or included with, a corresponding beacon signal, but this need not always be the case. The WTRE 504 may be transmitted at any suitable time following a beacon with relevant information about the transmission. The WTRE 504 may be transmitted by the AP to indicate to one or more corresponding STAs a time recommended for wakeup of each device, when the buffered units (BUs) are intended to be transmitted. In an embodiment, WTRE 504 may be carried in an existing broadcast frame, a unicast frame, or a new action frame. The WTRE element may generally include different subfields, each of which may include encoded information. The subfields or information encoded therein may include, for example, when the AIDs of the associated STAs for this WTRE 504 were provided, an indication of the time when each of the indicated STAs should awaken. The times may, for example, be encoded either in timing units (TUs), or as an identifier of the start time of the beacon interval segment. In the example of MLO, the time may correspond to the time synchronization function (TSF) of the link on which the indication is provided. In other embodiments, the time may refer to the timing synchronization function (TSF) of the link to which the recommendation applies. The times in the WTRE may further correspond to an indication of the duration for which the recommendation remains valid in cases where this technique is applicable. In other embodiments, the times may indicate whether the recommendation is a soft recommendation (optional) or a hard recommendation (mandatory), optionally along with a purpose for the recommendation. In the case of MLO, the times may include an indication of the link IDs for which the recommendation is valid. In some embodiments, the times may include an indication of a number of STAs assigned to the same wakeup time or a sequence number for the STA among the STAs assigned to the same wakeup time. In still other implementations, the time may include an indication of whether the AP will allocate downlink resources, uplink resources, or both for transmission at the recommended wakeup time. In addition, in some embodiments, the times may include an indication of whether an acknowledgment is to be sent or not, for the wake time recommendation in the WTRE 504. This acknowledgment can, for example, be sent either on the link in which the recommendation was sent or on the link(s) for which the recommendation is applicable, the latter in the case of MLO. In FIG. 5A, it is assumed that STA1 is provided by WTRE 504 (e.g., FIG. 5A) with a recommended wake-up time 506. In various embodiments, the AP may partition each Beacon Interval (BI) into constituent segments. STA1 may awaken in time to retrieve the BUs at the recommended wakeup time without incurring significant or unnecessary power losses.

FIG. 5B shows an example of a timing diagram 500B with multiple beacons and a signaling field including information about the WTRE, in accordance with an embodiment. In this example, the AP may elect to partition each BI 508.1, 508.2, and 508.3, etc., into 2^{X} segments, where 2^{X}=4 in this example. In a WTRE element 504 (e.g. FIG. 5A) associated with a beacon, an AP can indicate for each STA for which TIM bit is set to 1 starting from a certain AID k, a recommendation of the BI segment where the AP intends to serve the STA in the BI Segment Allocation List, shown here as the final segment in the identified WTRE element 555. The value of k may be indicated in the AID Offset subfield of the Wake Time Control Field. The value of X—in this case log 2([number of segments])—may be indicated in the Num Segments Exponent (X) subfield of the Wake Time Control field. It should be noted for clarity that the WTRE element 555 is measured with the unit value of octets (bytes), while the Wake Time Control subfield is expressed in bits.

Referring still to FIG. 5B, the BI segment indication for the m-th AID whose TIM bit is set to one (counting from AID k) is carried in the bits (m−1)X+1 to mX of the BI Segment Allocation List. The WTRE may be sent in the beacon 508.1, 508.2, etc. or in a broadcast, multicast, or unicast frame within the beacon interval following the beacon. The beacons are separated by a beacon interval which is partitioned into four segments in this example—Segments 0-3.

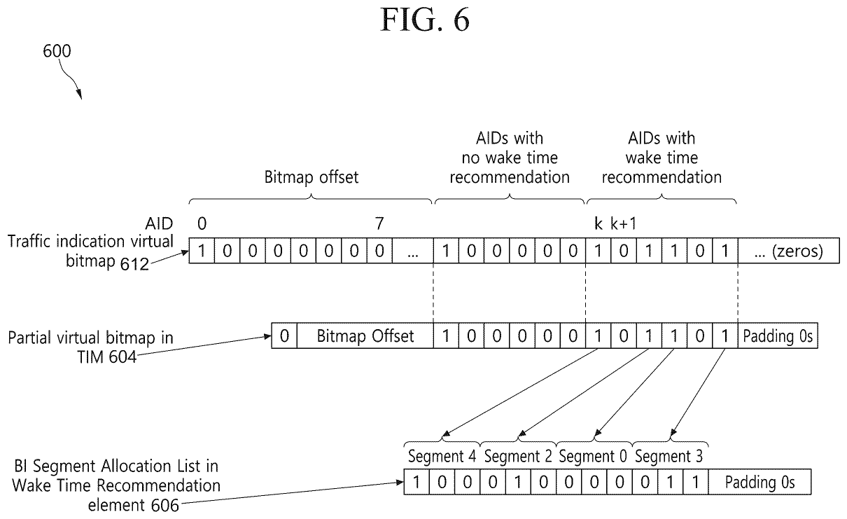

FIG. 6 shows an example Beacon Interval (BI) segment allocation list field for the WTRE of FIG. 5A, in accordance with an embodiment. The principles of FIG. 6 extend to the drawings of FIGS. 5A and 5B, in which timing diagram 500A with an AP beacon signal 502 (FIG. 5A)/508.1-508.3 (FIG. 5B) and including a Wake Time Recommendation Element (WTRE) 504 (FIG. A) is disclosed for providing a recommended wakeup time in accordance with an embodiment. The recommended segment may in one case be limited to the link in which the WTRE 504 is transmitted. In FIG. 6, the entries of the partial virtual bitmap 604 carried in a TIM element are partitioned into three categories: (1) the bitmap offset, (2) AIDs with no wake time recommendation, and (3) AIDs with wake time recommendations. The traffic indication virtual bitmap row 612 and the Partial virtual bitmap in TIM 604 correspond to existing bitmaps that are already present in a beacon. The third row shows the encoding of the BI Segment Allocation list of the WTRE 555 and its dependence on these existing bitmaps. In FIG. 6, the bits of the BI Segment Allocation List of the WTRE 555 (FIG. 5B) may be organized as shown in 606, with each segment serially indicated for each STA for which the Partial Virtual Bitmap has a value of 1 starting from an initial AID k. This value of AID k is indicated in AID Offset field of WTRE 555 in FIG. 5B. In this embodiment, the BI segment recommendation element 606 may either correspond to the beacon segments of the link in which the WTRE 504 was sent or to the beacon segments of the link for which the recommendation is intended. In an embodiment, the wakeup recommendation 506 applicable to STA1 may reside in the WTRE 504, in some cases along with an identification of the purpose of the recommendation or if the recommendation is hard or soft (mandatory or optional). The data in FIG. 6 provides mechanisms for an AP MLD to indicate to one or more non-AP MLDs a recommended wake-up time for them on one or more links. FIG. 5A shows an embodiment for an AP or an AP MLD to indicate to one or more associated non-AP STA(s) or non-AP MLD(s) when it intends to serve them on one more link(s). This mechanism can help the non-AP STAs determine when they should transfer to the awake state. The procedures can also assist with network traffic management, latency reduction, multi-AP coordination, and significant power savings, to name a few benefits.

The bitmap in FIG. 6, therefore includes cross-link indications that enable links in MLO scenarios to discover whether a wakeup time is associated with these non-AP links. Thus, in a first embodiment involving MLO, the recommended segment can be applicable only to the link where the WTRE is transmitted. In another embodiment involving MLO, there can be a Link ID or Link Bitmap field indicating all applicable links. In this case, the segment indication may either correspond to the beacon segments of the link where the recommendation was sent or may correspond to the beacon segments of the link for which the recommendation is intended.

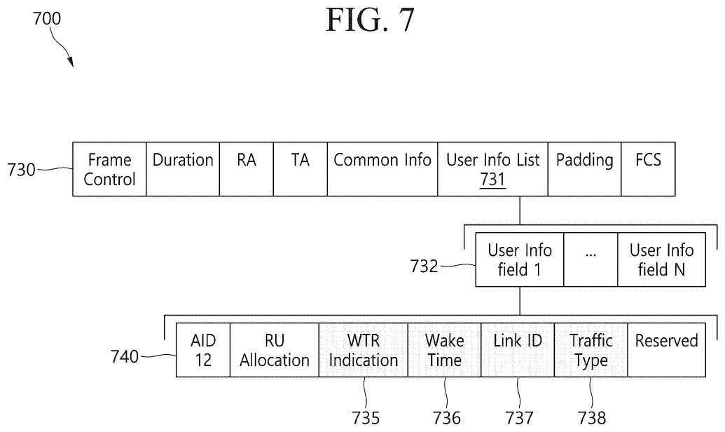

FIG. 7 shows an example of using a Multi-User-Request To Send (MU-RTS) trigger frame as a criterion for wake-up recommendation in accordance with an embodiment. In this implementation, the indication of the wake time recommendation may be carried in a trigger frame, such as here, a multi-user-request to send (MU-RTS) frame 730, a buffer status report poll (BSRP) frame, or a unique variant of such a frame. For each STA for which the wake time recommendation is intended, the AP may include a User Info List field 731 with User Info subfields {1-N} 732, each corresponding to the AID of that STA within the trigger frame. The User Info List field 731 may have a format similar to those of other embodiments, in that the User Info List field 731 is partitioned into a plurality of N User Info fields 732. Each of the N User Info fields 532 may also include a Wake Time Recommendation (WTR) indication subfield 735. The purpose of the latter field in this embodiment is to indicate that the applicable User Info field 732 is for wakeup time recommendation for the associated STA. The User Info field 732 may also include a Traffic Type subfield 738 indicating the type of traffic to be delivered at the indicated wakeup time. Examples of the “type” of traffic include downlink or uplink traffic. In some configurations, a “reason code” field may be included in the User Info Field 732 to identify the reason for the wakeup time recommendation. In the case of MLO, the link for which the recommendation applies may also be located in the Link ID subfield 737 of the User Info field 732 of the trigger frame. In another configuration, the STAs are expected to transmit a response to the trigger frame indicating whether or not they will comply with the recommendation. The response may be solicited by the AP on the link where the trigger frame was sent or can be solicited on the link for which the recommendation is deemed applicable.

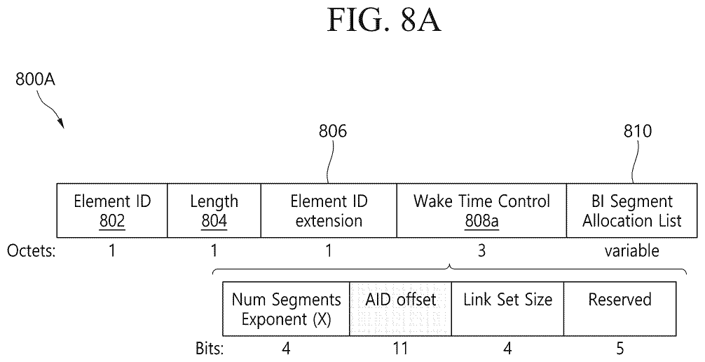

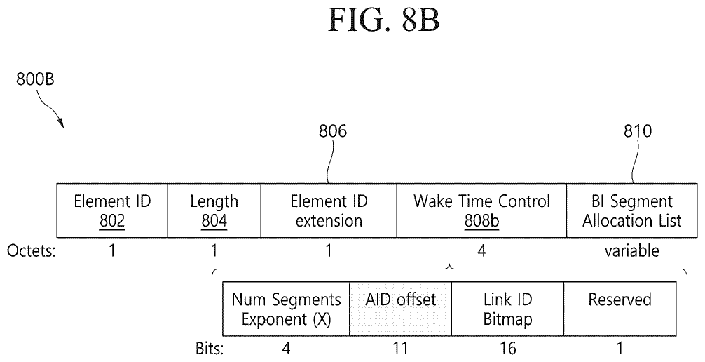

In another embodiment, the Wake Time Recommendation element 504 (FIG. 5A) can provide a BI segment indication for multiple links. FIG. 8A shows an example of a WTRE element 800A providing a BI segment indication for multiple links by indicating a Link Set Size, in accordance with an embodiment. The WTRE element 800A in this embodiment includes the fields Element ID 802, Length 804, Element ID extension 806, Wake Time Control 808a, and BI Segment Allocation List 810. In this configuration, there may be a Link Set Size subfield in the Wake Time Control field 808(a) of the WTRE element 800A to indicate the number of links for which the recommendation is provided. For example, if the Link Set size is set to a value L, then the recommendation is for Link IDs {0, 1, . . . , L−1}.

In some embodiments involving MLO, there can be a Link ID or a Link Bitmap field indicating all applicable links. In this situation, the segment indication may either correspond to the beacon segments of the link where the recommendation was sent, or alternatively, to the segment indication may correspond to the beacon segments of the link for which they were intended. In another variation, there can be a Recommendation Type field in the WTRE message element 800A (e.g., the reserved subfield in the wake time control field 808a) that provides yet additional details, flags or codes about the purpose and the nature of the Recommendation. Alternatively, or additionally, in this embodiment, instead of the Link Set Size subfield, there can be a Link ID Bitmap subfield to indicate all the link IDs for which the BI segment indication of WTRE 800A provided are applicable.

Thus, in another example, FIG. 8B shows an embodiment of a WTRE element 800B having subfields using an AID offset and a link ID bitmap subfield in a wake time control filed 808b in accordance with a further embodiment. In this example, as alluded to above, the Link Set Size is replaced with a Link ID bitmap subfield of the wake time control field 808b for identifying all the links to which the WTRE will apply. The BI segment indication can be carried in the one or more Per-link BI Segment Allocation List subfield(s) of the BI Segment Allocation List field 810 of the WTRE element 800B.

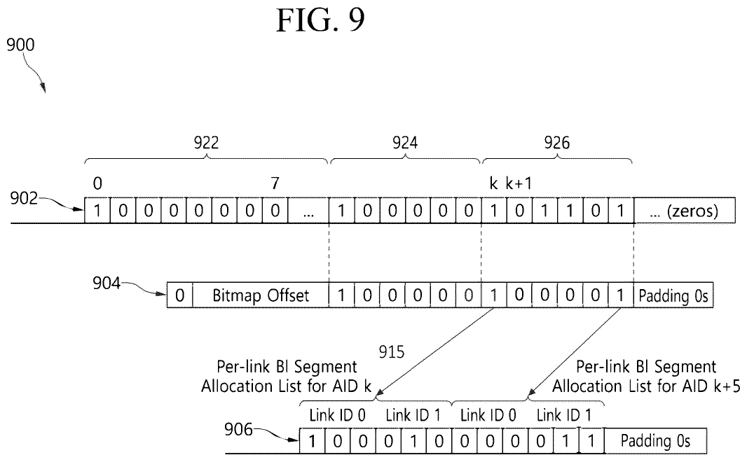

FIG. 9 shows an example of a Traffic indication virtual bitmap 900 in accordance with an embodiment. The bitmap is indicated using reference number 906. the BI segment Allocation List field at 906. The BI segment indication can be carried in the one or more per-link BI Segment Allocation List field 915 of the WTRE. The m-th per-link BI segment Allocation List Field of the BI Segment Allocation List field 906 carries the indication for the m-th AID whose TIM bit is set to one (counting from AID k). Each Per-link BI Segment Allocation List may have XL bits, where L is the value in the Link Set Size (or the number of bits set to 1 in the Link ID Bitmap) of the Wake Time Control field 808b (FIG. 8B). The first X bits of the list indicate the BI Segment for Link ID 0 (or first link whose bit is set to 1 in the Link ID bitmap), the next X bits for link ID 1 (or the second link whose bit is set to 1 in the Link ID bitmap) and so on. In FIG. 9, the bitmap offset 922 traverses the first column of the traffic indication virtual bitmap 902 and the partial virtual bitmap in TIM 904; the AIDs with no wake time recommendation 924 traverses the second column of bitmap 902 and the partial virtual bitmap in TIM 904; and the AIDs with wake time recommendation 926 traverses the third column of rows 902, 904 and 906. The first and last digits in the row 904 correspond (via the arrows) to the corresponding per-link BI segment Allocation list for AID k and AID k+5.

In another aspect of the disclosure, the AP may segment the beacon into different segments, like earlier embodiments.

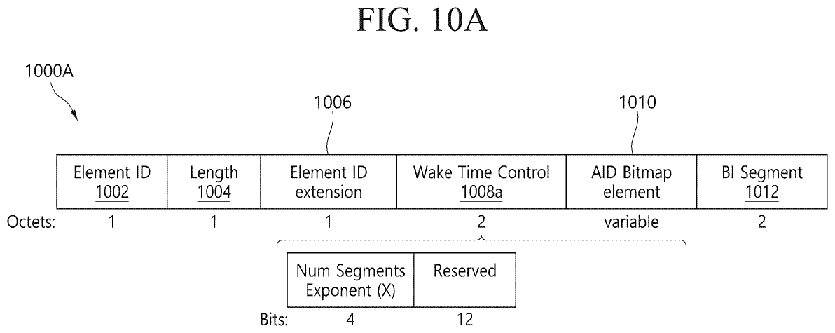

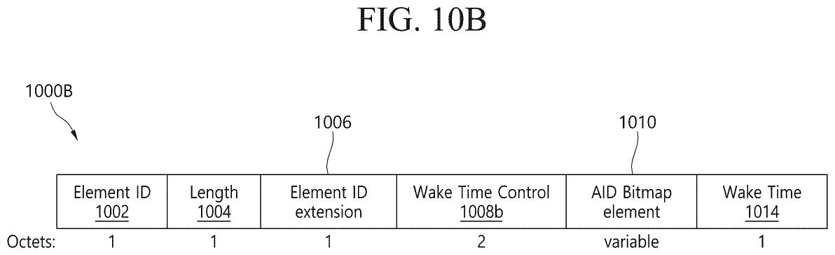

FIG. 10A and FIG. 10B shows a WTRE element 1000A and 1000B, respectively. WTRE element 1000A has an Association Identifier (AID) Bitmap element 1010 for use in identifying all the AIDs for which the Wakeup time indication applies. An objective of these fields is to provide a common wake time for all the AIDs identified in the bitmap 1010. That is, all the indicated AIDs may be assigned the same wake time indicated using the BI segment field 1012 in the WTRE element (1000A of FIG. 10A) or the wake time (WTRE 1000b of FIG. 10B). With reference to FIG. 10A, each of the indicated AIDs may be assigned the same wake time indicated using the BI Segment field 1012. The BI Segment field 1012 indicates the start time within the segment at the beacon interval where the AP is requesting the STA(s) to initiate wakeup. In another embodiment, instead of the BI segment field 812, a WTRE field 1000B is introduced that includes a wake time subfield 1014, as in FIG. 10B. The wake time subfield 1014 indicates the time where the AP indicates the STA to wake up. The wake time may be in units of TUs and can indicate the number of TUs from the most recent target beacon transmission time (TBTT) when the STAs identified in AID Bitmap element 1010 are requested to awaken. In another embodiment involving MLO there may also be a link field indicating the link for which the recommendation is valid. In this case, the segment indication may either correspond to the beacon segments of the link where the recommendation was sent, or to the beacon segments of the link for which the recommendation is intended. FIG. 10B shows a WTRE using a Wake Time field that indicates the time where the AP indicates the STA(s) to wake up, in accordance with an embodiment.

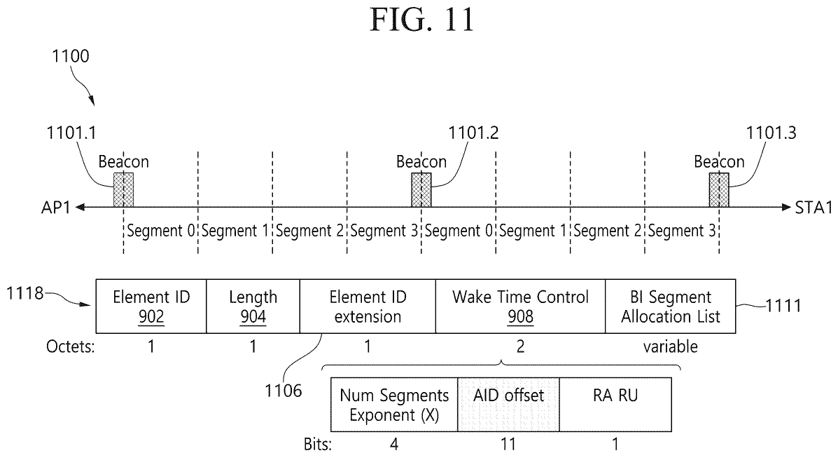

FIG. 11 shows another timing diagram 1100 with a sequence of beacons 1101.1, 1101.2, 1101.3 and a WTRE element 1118 using an AID offset and a random access resource unit (RA RU), in accordance with an embodiment. Each BI segment may be initiated with a trigger frame by the AP to enable all awakening STAs to transmit respective PS polls in parallel to the AP via uplink orthogonal random access (UORA). Thereupon, following these operations, the AP may perform multi-user transmission to the STAs. Alternatively, or additionally, the AP may send a Buffer Status Report Poll (BSRP) trigger frame to the STAs, in response to which the AP receives Buffer Status Reports from the STAs. In an embodiment, the provision of such trigger frame(s) at the beginning of a segment can be optional. The presence of the trigger frame(s) in a segment can alternatively be indicated by the RA RU subfield nestled within the wake time control field 1108. The identification of the element at issue, its length and extension are labeled 1102, 1104, and 1106, respectively. The variable BI Segment Allocation List 1111 functions like those in previous embodiments.

When the recommendation is sent on one link but is intended in fact for another link, the wakeup time may be selected to account for the delay experienced by the recipient to pass the wake recommendation to the proper link. This phenomenon (e.g., “Cross-link Wakeup Delay”) may be indicated by an STA to the AP during the association process in its ultra-high reliability (UHR) physical layer signaling or its medium access control (MAC) Capabilities elements.

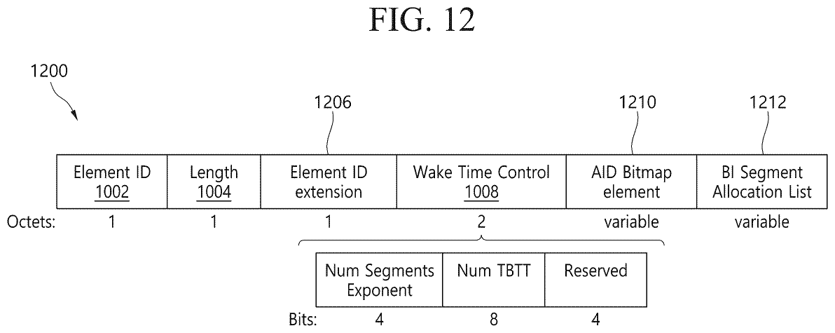

In another aspect of the disclosure, the AP may use a WTRE to indicate, for a subset of associated non-AP STS/s or MLDs, a so-called “long term” recommendation of the time when the AP intends to serve the STA if the AP has BUs for the STA. FIG. 12 shows a WTRE element 1200 using subfields for wake time control in accordance with an embodiment. In one configuration, the indication of the time specifying the anticipated wakeup can be carried in a BI Segment Allocation List 1212. Unlike in earlier embodiments, however, the STAs for which the BI segment indication is provided can be identified using the AID bitmap field 1210 of the WTRE. Further, the AID Bitmap field may carry an AID Bitmap element 1210 that provides a list of AIDs of STAs associated with the AP. The BI segment indication for the m-th AID identified in the AID Bitmap may be carried in the bits {(m−1)X+1−mX} of the BI Segment Allocation List field. The WTRE element 1200 can be sent in a broadcast frame and can be applicable for each target beacon transmission time (TBTT) until it is torn down or until an indicated expiration TBTT, as indicated in the Num TBTT subfield of the Wake Time Control field 1208. In one embodiment, this element can be an extension of an existing frame, such as the existing Link Recommendation frame. In one embodiment involving MLO, the recommended time can be made applicable across all the enabled links for a non-AP MLD. In another configuration involving MLO, the recommended time can be applicable to the link where the WTRE element 1200 is transmitted. In yet another embodiment involving MLO, a link ID bitmap or link ID field can be present in the WTRE element 1200 that identifies the links to which the wake-up recommendation is applicable. In one embodiment, a per-link BI segment indication can be provided in the WTRE 1000, as in embodiments above. In still another configuration, a Recommendation Type field (RTF) can be provided. The RTF identifies the purpose of the recommendation, and related factors such as whether the recommendation is a hard or soft recommendation. In another embodiment, instead of a BI Segment Allocation List 1212, the WTRE 1200 may incorporate a BI Segment or Wake Time field (as in embodiments above). In this case, all the AIDs identified in a WTRE are assigned the same long-term wake time. Multiple WTREs may be transmitted to cover STAs that are recommended to wake up at different long-term wake-times.

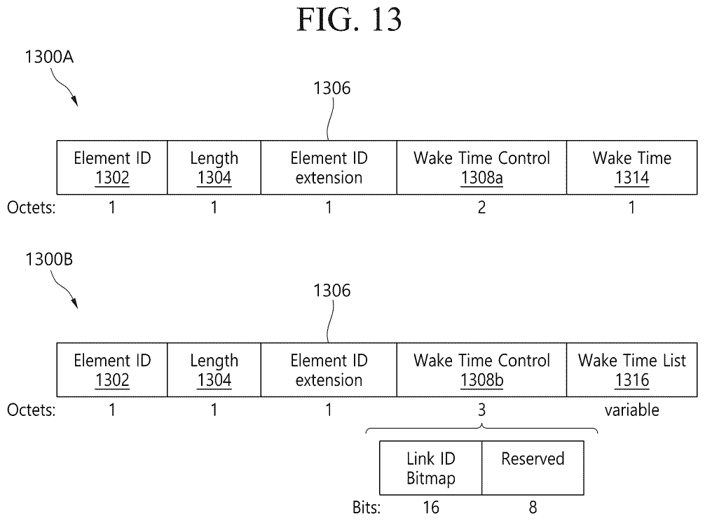

FIG. 13 shows an example of transmitting WTREs 1300A and 1300B in individually addressed frames to the non-AP STA/MLD, in accordance with an embodiment. In an example of 1300A, an AP can transmit the WTRE in an individually addressed frame to the non-AP STA/MLD to indicate, for a STA, a recommendation of the time where the AP intends to serve the STA. The indication of the time can be carried in a Wake Time field 1314, for example, or in another available field. In one embodiment involving MLO, the recommended time can be applicable across all the enabled links in the Link ID bitmap of the wake time control field 1308 for a non-AP MLD in which the identity of the link(s) to which the wake-up recommendation applies is included. In sum, in WTRE element 1300A, of the element ID 1302, length 1304 element ID extension 1306, and wake time control fields 1308, the wake time is stored in wake time field 1314. In WTRE element 1300B, the elements are the same in name except for the last field, or the wake time list 1316. The wake time list can be a variable field containing multiple wake times that can be mapped to the multiple links as indicated in the link ID bitmap of the Wake Time Control 1308b.

These technique beneficially enables data to be exchanged on one or more specified links using, for example, in the case where certain frequency bands are deemed optimal while others may be bandwidth-overloaded. In another example, a per-link Wake Time indication can also be provided in the WTRE 1100B (as in an earlier example), as depicted in FIG. 11. In an additional embodiment, a Recommendation Type field, which identifies the purpose of the recommendation or if the recommendation is a hard or soft recommendation, can be included within WTRE 1100B. For FIG. 13, the AP can also transmit a WTRE in an individually addressed frame to the non-AO STA or MLD to indicate a single time recommendation, as described above.

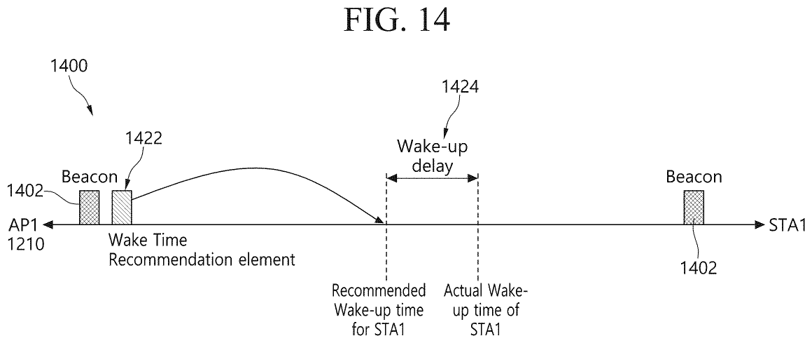

FIG. 14 shows an example timing diagram 1400 where a STA (“STA1”) can negotiate with an AP for providing an additional wake-up delay 1424 for adding to the recommended wake-up time, in accordance with an embodiment. A non-AP STA (“STA1”) can optionally negotiate with an AP 1410, asking the AP to provide STA1 a WTRE 1422. Thereafter, AP 1410 may provide a response frame indicating success or failure of the operation.

In one implementation, if after sending the beacon 1402 the AP 1410 indicates WTRE recommendation 1422 to be a hard recommendation, STA1 may not violate it and/or may not need to explicitly transmit a PS poll frame to indicate that STA1 has transitioned to the awake state. In another example, at a delayed wake up time which is the recommended wake time plus the wake up delay 1424, each of the indicated STAs may refrain from transmission for a grace period from the start of the indicated wake-up time. This option may be implemented when, for example, the AP indicates that it will provide a random-access resource unit (RA-RU) or triggered uplink access for transmission of PS-polls or data. If this is the case, each of the indicated STAs may wake up at any one of these times:
(i) at the indicated wake-up time. In one variant, although the STA wakes up at the indicated wake up time, its back-off counter can be set based on the number of STAs with lower AIDs that have been assigned same wake-up time in the WTRE.
(ii) at a delayed wake-up time, where the delay can be determined by how many STAs with lower AIDs have been assigned the same wake-up time in the WTRE.
(iii) at a random delayed wake-up time, where the range for the random delay can be determined by how many STAs with have been assigned the same wake-up time in the WTRE. This is to minimize the chance of collision.

In short, FIG. 14 shows the delayed-wake up time configuration 1424. The delayed wake up time represents the difference between the recommended wake-up time for STA1 and the actual wake-up time of STA 1. Subsequently, another cycle is initiated as a new beacon 202 is transmitted. It should be noted that the illustration applies to a delayed wake up followed by a STA based on a number of other STAs assigned the same wake time (assuming there is no RA-RU allocation). The WTRE may also have an AID bitmap field identifying the AIDs of the STAs that are members of that specific SP and for which the wake time period is provided. In the configuration that includes a Wake Time field, the wake time may indicate an offset time from the start of the SP. The WTRE can be transmitted as a group-addressed frame at the beginning of each such SP, or in case of long-term recommendation, the WTRE can be transmitted infrequently.

In short, in many instances, this embodiment obviates the need for a resource-consuming PS polls and provides lower latencies. In addition, decreasing the chances of collision can help increase overall bandwidth of the system.

In sum, the AP may use the wake-up recommendations for recommending wake times within specific periodic service periods (SPs), rather than the entire beacon interval as depicted in embodiments above. Such a periodic interval can be, for example, a broadcast TWT service period or a restricted TWT service period or the beacon interval that follows a DTIM beacon. In this manner, the existing concept of “BI segment” can be replaced by an “SP segment,” thereby providing a SP segment Allocation List subfield in the WTRE as described in greater detail below.

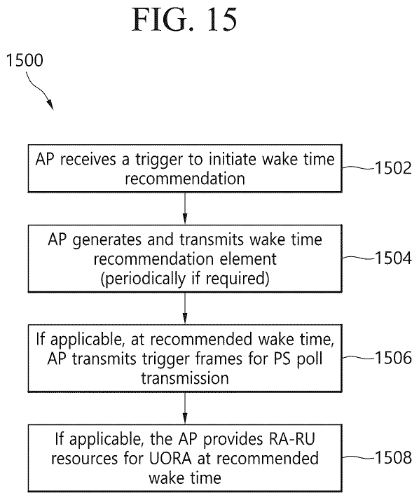

FIG. 15 shows an example flow diagram 1500 of a process for recommending, by an AP, a wake time in accordance with an embodiment. While FIG. 15 shows a sequence of steps performed by an AP for wake time recommendation, other possibilities may exist without departing from the scope of the disclosure. That is, the scope of this example flowchart in FIG. 15 is nonexhaustive in nature and is for purposes of illustration only and shall not be used to reduce the scope of the embodiments in this disclosure.

With initial reference to FIG. 15, the AP at block 1502 may receive a trigger to initiate a wake time recommendation. At block 1504, the AP generates and transmits a WTRE. If required, the WTRE is configured by the AP to be transmitted periodically. Thereupon, if applicable at block 1506, at the recommended wake time, the AP transmits trigger frames for PS poll transmission. Otherwise, if applicable at block 1508, the AP provides RA-RU resource for UORA at the recommended wake time

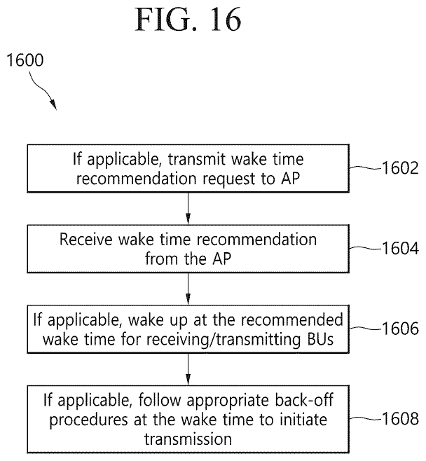

FIG. 16 shows another example flow diagram 1600 of a process for recommending, by an AP, a wake time in accordance with an embodiment. While FIG. 16 shows a sequence of steps performed by a STA for wake time recommendation, other possibilities may exist without departing from the scope of the disclosure. That is, the scope of this example flowchart in FIG. 16 is nonexhaustive in nature, for purposes of illustration only, and shall not be used to reduce the scope of the embodiments in this disclosure.

The operations in FIG. 16 are unlike those of FIG. 15, performed by the STA. Referring first to block 1602, where applicable in the context of the receiving the appropriate prompt, the STA transmits a wake time recommendation request to the AP. Next, at block 1604, the STA receives a wake time recommendation from the AP. At block 1606, assuming that a wake time recommendation has been received from the AP, the STA wakes up at the recommended wake time for receiving or transmitting BUs. At block 1608, the STA follows the appropriate back-off procedures at wake-time to initiate transmission while reducing collision likelihood. In some embodiments as shown in FIG. 12, for example, there will be a delay between the recommended wake-up time for the STA and its actual wake-up time. The net result of these procedures is a fast network with reduced latency, less network congestion, less network idle time, greater certainty, and lower consumption of power.

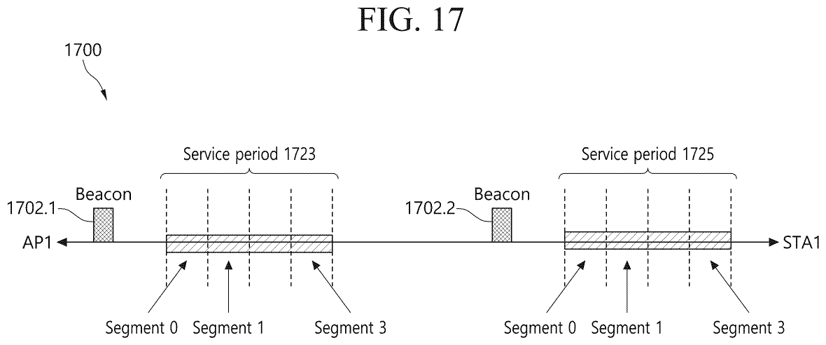

In another aspect of the present disclosure, the AP may use the above-described wakeup recommendation methods for the purpose of recommending wake times within specific service periods (SPs) as opposed to the entire beacon interval. An example of this technique is set forth in FIG. 17, which is a timing diagram 1700 illustrating a beacon 1702.1 and a three-segment service period 1723. FIG. 17 shows an interaction between AP1 and STA1 over the time interval defined by beacons 1702.1 and 1702.2 and respective service periods 1723 and 1725. Such a periodic interval can be, for example, a broadcast TWT SP, a restricted TWT SP or the beacon interval that follows a Delivery Traffic Indication Message (DTIM) beacon.

In this aspect, the concept of “BI Segment” can be replaced by a “SP Segment,” and a SP Segment Allocation List subfield may be included in the subject WTRE element. The WTRE may also include an AID bitmap field identifying the AIDs of the STAs that are members of that specific SP and for which the wake time recommendation is provided. Thus, for example, FIG. 17 illustrates two example beacon intervals, each of which includes a defined SP 1723 and 1725. Each SP 1723 or 1725 can be further partitioned into SP segments. While the number of SP segments may vary depending on the embodiment, each SP in FIG. 15 includes three SP segments. In embodiments that include a Wake Time field, the Wake Time may indicate an offset time from the start of the SP. The Wake Time Recommendation element can be transmitted as a group-addressed frame at the beginning of each such SP (e.g., SP 1723 or SP 1725), or in case of long-term recommendation, the WTRE can be transmitted infrequently only when there is a change to the scheduling, for example.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner like the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. The described instructions, operations, and systems can be integrated together into a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP), comprising:
a memory; and
a processor coupled to the memory, the processor configured to:
transmit, to one or more stations, a wake time recommendation element (WTRE), the WTRE including at least (i) an identity of one or more stations; and (ii) a recommended wake time after transmission of the WTRE for the one or more stations to transmit or receive data beginning at the wake time; and
receive, at the recommended wake time from the one or more stations, an indication that the one or more stations are ready to exchange data with the AP.

2. The AP of claim 1, wherein the recommended wake time is determined based on at least one of:
a time synchronization function corresponding to an intended wake time;
one or more transmit units corresponding to a time gap between transmission of the WTRE and the intended wake time, or
an identifier of a beacon segment corresponding to the intended wake time, wherein a beacon interval following transmission of the WTRE is partitioned into equal-length beacon segments.

3. The AP of claim 1, wherein the WTRE includes an indication of whether the recommended wake time is for transmission of: downlink traffic from the AP to the one or more stations; uplink traffic from the one or more stations to the AP; or bidirectional traffic for the one or more stations.

4. The AP of claim 1, wherein the WTRE includes an indication of whether the recommended wake time is for AP-initiated or triggered transmissions.

5. The AP of claim 1, wherein the WTRE includes:
an indication whether the at least one recommended wake time is optional or mandatory; and
a purpose of the recommendation.

6. The AP of claim 1, wherein the AP is an AP multi-link device (MLD) including one or more affiliated APs, and the AP MLD establishes one or more links, each link associated with a respective one of the one or more affiliated APs; and
during multi-link operation (MLO), the WTRE is configured to indicate one or more links for which the WTRE is valid.

7. The AP of claim 1, wherein the WTRE includes a number of stations assigned to a same recommended wake time or a sequence number among the stations assigned the same recommended wake time.

8. The AP of claim 1, wherein the WTRE includes an indication whether the recommendation is a long-term recommendation to continue for at least one station over a prescribed time period.

9. A station in a wireless network, comprising:
a memory;
a processor coupled to the memory, the processor configured to:
transmit a request to send a wake time recommendation element (WTRE) to an access point (AP);
receive, from the AP, the WTRE including at least (i) an identity of one or more stations; and (ii) a recommended wake time after transmission of the WTRE for the one or more stations to transmit or receive data beginning at the recommended wake time;
wake up at the recommended time; and
transmit, at the recommended time, an indication that the station is ready to exchange data with the AP.

10. The station of claim 9, wherein the processor is further configured to:
follow, in an event of an impending or existing collision between respective transmissions, back-off procedures identified by the AP; and
re-initiate transmission at a designated time to retrieve traffic from the AP after completing the back-off procedures.

11. The station of claim 9, wherein the processor is further configured to:
receive a trigger frame from the AP requesting the station to transmit a power-save (PS) poll frame at the recommended wake time;
transmit the PS poll frame to the AP at the recommended wake time.

12. The station of claim 9, wherein one or more of the stations comprise non-AP stations.

13. The station of claim 9, wherein:
the WTRE includes an indication of a duration that the recommended wake time will remain valid; and
the station is configured to awaken to perform frame exchanges with the AP at the recommended wake time.

14. The station of claim 9, wherein the station is a non-AP multi-link device (MLD) including one or more affiliated non-AP stations, and the non-AP MLD establishes one or more links, each link associated with a respective one of the one or more affiliated non-AP stations; and
during multi-link operation (MLO), one or more affiliated non-AP stations transition to an awake state at the recommended wake time on recommended links, the recommended links being indicated by link identifiers included in the WTRE.

15. The station of claim 9, wherein the WTRE includes an indication whether the recommendation is a long-term recommendation to continue for at least one station over a prescribed time period.

16. A method performed by an Access Point (AP), the method comprising:
transmitting, to one or more stations, a wake time recommendation element (WTRE), the WTRE including at least (i) an identity of one or more stations; and (ii) a recommended wake time after transmission of the WTRE for the one or more stations to transmit or receive data beginning at the wake time; and
receiving, at the recommended wake time from the one or more stations, an indication that the one or more stations are ready to exchange data with the AP.

17. The method of claim 16, wherein the WTRE includes an indication of a duration that the recommended wake time will remain valid.

18. The method of claim 16, wherein the WTRE includes:
an indication whether compliance with the at least one recommended wake time is optional or mandatory; and
a purpose of the recommended wake time.

19. The method of claim 16, further comprising determining the recommended wake time based on at least one of:
a time synchronization function corresponding to an intended wake time;
one or more transmit units corresponding to a time gap between transmission of the WTRE and the intended wake time, or
an identifier of a beacon segment corresponding to the intended wake time, wherein a beacon interval following transmission of the WTRE is partitioned into equal-length beacon segments.

20. The method of claim 16, wherein the WTRE includes an indication whether the recommendation is a long-term recommendation to continue for at least one station over a prescribed time period.
